(19) United States
(12) Patent Application Publication
(10) Pub. No.: US 2016/0087993 A1
(43) Pub. Date: Mar. 24, 2016

(54) Selectively Managing Datasets

(71) Applicant: MICROSOFT CORPORATION, Redmond, WA (US)

(72) Inventors: Meera Jindal, Medford, MA (US); Kristofer Hellick Reierson, Acton, MA (US); Neil Adam Jacobson, Acton, MA (US); Alemeshet Yismaw Alemu, Issaquah, WA (US); Lidiane Souza Jones, Cambridge, MA (US)

(21) Appl. No.: 14/490,941

(22) Filed: Sep. 19, 2014

(51) Int. Cl. H04L 29/06; G06F 21/60; G06F 17/30

(52) U.S. Cl. CPC H04L 63/105; G06F 17/30867; G06F 17/30876; G06F 21/604

(57) ABSTRACT

Selectively wiping data. A method includes identifying a plurality of datasets on a device. The method further includes identifying one or more datasets, on a dataset basis, from among the plurality of datasets that are managed datasets associated with a particular user account by being associated with an account identifier for the particular user account at a data structure external to the device. The managed datasets are associated with a particular user account by being associated with an account identifier for the particular user account. The method further includes receiving an indication that managed data associated with the particular user account should be wiped from the device. The method further includes wiping the one or more datasets that are identified as being managed datasets associated with a particular user account while not wiping datasets from the plurality of datasets that are not associated with the particular user account.

### BACKGROUND

1. Background and Relevant Art

Computers and computing systems have affected nearly every aspect of modern living. Computers are generally involved in work, recreation, healthcare, transportation, entertainment, household management, etc.

Recently, there has been an explosion of personal mobile computing devices such as smart phones and tablets. Often, a user will purchase a mobile computing device for personal use, but will desire to also use the device to access resources for their job or another organization with which they are associated. This is often referred to as the “bring your own device” (BYOD) model.

When a personal device is used to access corporate or other organization resources, the organization will want to ensure that the device meets certain compliance policies and has certain controls granted to if of the organization. For example, the device may be required to be password protected. The device may be required to allow IT to wipe the device in case the device is lost or stolen, or when the individual is no longer associated with the organization. However, there is a need to balance an organization's need to control data with an individual's desire to maintain control of their personal data. Thus, a user may not wish for their personal data to be wiped when a device is wiped.

Selective wipe is the ability of an administrator of an organization to remove only organization data from a computing device that is not owned by the organization but contains organization assets. For example, an information worker could have a personal device, such as a phone. This device could be used for work activities and have organization data on it (as well as personal data unassociated with the organization). If the information worker is terminated, the administrator would like to be able to wipe the corporate information selectively and leave all personal data behind. To do this, there is a need to know what is organization data, and what is not organization data. There may be a particular need to perform such functionality when an application is not aware of the distinction. In particular, a given application may simply see all data as application data, without distinguishing between personal and organization data.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing environment. The method includes acts for managing datasets on a device for improved efficiency in identifying and operating on managed datasets. The method includes identifying that a user of an application on a device wants to create a dataset using the application. The method further includes identifying a user account, from among a plurality of user accounts associated with the user, on the device, to be used for a dataset creation process. The method further includes the application creating the dataset. The method further includes associating the identified user account with the dataset by associating an account identifier with the dataset. The method further includes causing an association of the account identifier and the dataset to be stored external to the application.

Another embodiment may be a method practiced in a computing environment. The method may include acts for selectively wiping data from a device. The method includes identifying a plurality of datasets on a device. The method further includes identifying one or more datasets, on a dataset basis, from among the plurality of datasets that are managed datasets associated with a particular user account by being associated with an account identifier for the particular user account at a data structure external to the device. The managed datasets are associated with a particular user account by being associated with an account identifier for the particular user account. The method further includes receiving an indication that managed data associated with the particular user account should be wiped from the device. The method further includes wiping the one or more datasets that are identified as being managed datasets associated with a particular user account while not wiping datasets from the plurality of datasets that are not associated with the particular user account.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 illustrates an environment where a selective wipe can be performed with a cooperative application;

FIG. 2 illustrates an environment where a selective wipe can be performed with a non-cooperative application;

FIG. 3 illustrates a method of managing datasets on a device;

FIG. 4 illustrates a method of selectively wiping data front a device.

### DETAILED DESCRIPTION

Embodiments may include functionality for associating an identifier with a dataset (such as a document, file, database entry, or other dataset) where the identifier identifies an account. In this way, an account is associated with a dataset. If data for an account is to be wiped, such as data from a corporate account, any data associated with the account can be wiped while not wiping any data not associated with the account by wiping only data with the identifier associated with it.

Associating the dataset with an account identifier can be accomplished in a number of different fashions. For example, in some embodiments, the application can determine what account is active, and then tag any datasets created with the application with an identifier for the active account. For example, consider an email program that manages several accounts. A user can select an inbox (or other folder) associated with one of the accounts to be in focus. The user can then compose an email while this inbox is in focus. An identifier associated with that account will be associated with the composed email, thus associating the email with the account.

In an alternative example, embodiments can use natural language processing or a ‘grep’ to look at the contents of the document to determine an account associated with the document.

In an alternative embodiment, a user may explicitly associate an account with a dataset on dataset creation. For example, a user may again compose an email from an email application. The email application may not have functionality for determining which account the composed email should be associated with. However, after the user indicates a desire to compose an email, the user may be presented with a dialog box (or other user interface) with a picker that allows the user to select an account. An identifier for the user selected account will then be associated with the composed email.

The following illustrates various details. In particular, a first portion of the following description describes an overall system. This shows how embodiments can determine what data needs to be wiped when a signal is received to perform a selective wipe. A second portion of the following description describes additional functionality that can be implemented to deliver a selective wipe when an application is not written for identifying accounts (or is not-cooperating) in the overall system.

Overall System

As mentioned previously, embodiments should be configured to determine what data to wipe from a device when a selective wipe signal is received. If all data is removed from the device in a wipe operation, personal data will be removed from the device, disappointing the owner of the device when their data is lost. To avoid this, embodiments correlate who owns the data in a particular document (or other dataset) with a user, and more particularly with a user account. To do this, embodiments tag each file with an account identifier for the user account used to create the data. For example a user may have multiple email accounts in an email program. The Information Worker (IW) needs to choose which account the email will originate from. In the illustrated example, this method is applied to all document creation, so that if the IW creates a new email or word processing document, the email or word processing document is correlated, with an account for the user that created the document. Some embodiments may keep a table that tracks file name to account, instead, of modifying the document directly. This could be used, for example, in cases where the local computer does not support extended metadata on file types.

This allows embodiments to know which account created a document. When a wipe command is received, embodiments need to know which account should have their data removed. This can be done by saving the account identifier for the user who enrolls a device with an organization. Enrolling a device may include, for example, logging into a company website and agreeing to be managed. When this happens, the enrollment service saves the account identifier and a device identifier. Alternatively, an IT pro can provision the device with a particular user's identity. That way the user does not need to go to the website, rather, it happens automatically.

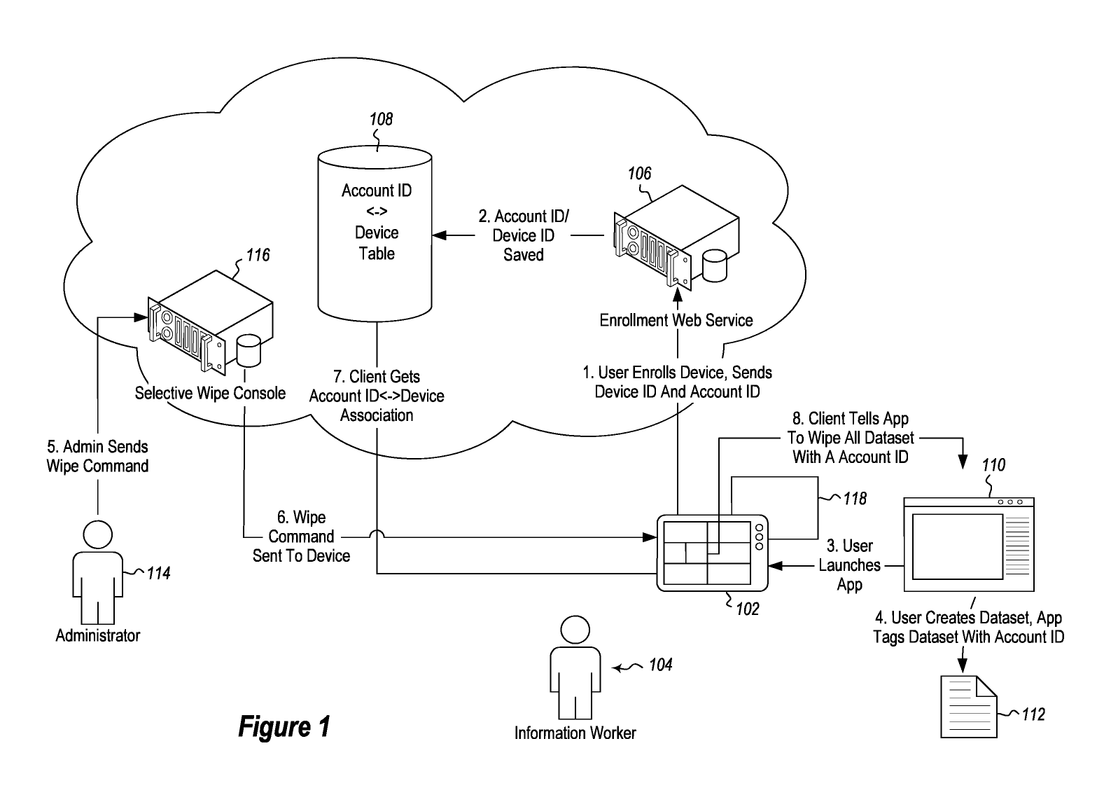

When a selective wipe is requested, an agent in the application (or a component external to the application that can share information about the wipe with an agent in the application) gives the enrollment service the device identifier, and receives the account identifier recorded earlier. Alternatively, part of the enrollment process could be identifying the corporate account. If this is performed, embodiments do not need the enrollment service to get the account identifier. The agent then tells the client application to remove all files tagged with that account identifier which leaves all personal data on the device, while removing organization assets. An example of this is illustrated in FIG. 1. FIG. 1 illustrates an environment where embodiments can be practiced and an example flow. In particular, FIG. 1 illustrates a cooperative environment example where an application is configured to perform a selective wipe. This may be implemented, for example, by using applications provided by an organization such that the organization can protect their organization data.

FIG. 1 illustrates a device 102. The device may be, for example, a mobile phone, tablet, or other computing device. The device 102 may be, for example, a personal device of a user 104. However, embodiments may also be implemented where the device 102 is a less (or non) portable device and/or when the device 102 is a corporate or organization asset. The user 104, as illustrated at step 1, enrolls the device 102 by sending a device identifier and an account identifier to an enrollment web service 106. As illustrated at step 2, the account identifier and device identifier are correlated in a data structure 108, such as a table.

As illustrated, at step 3, the user 104 launches an application 110 on the device 102. The application 110 is used by the user to create a dataset 112 (a document in the example, illustrated). The application 110 will tag the dataset 112 with the account identifier.

At some later time, as illustrated at step 5, an administrator 114 sends a wipe command to a selective wipe console 116. As illustrated at step 6, a wipe command is sent to the device 102. As illustrated at 7, a client 118 at the device 102 obtains the account identifier for the account from the data structure 108. The client could be, for example, a mobile device management (MDM) agent running on the device. In one example the MDM agent has device administrator capabilities such as setting the device PIN policy, but it does not have the ability to see into the sandbox of other applications to wipe the application data Instead it tells the individual applications to wipe their corporate data. Alternatively, a client could be code running inside the process such as a mobile application management SDK with which the application is built. This SDK can expose APIs which can notify the application when it should perform a wipe.

As illustrated at step 8, the client 118 at the device 102 tells the application 110 to wipe all datasets associated with the account identifier. In an alternative example, when there is no client, the application contacts a service to ask whether or not the corporate data should be wiped. The application 110 then wipes the datasets associated with the account identifier. Wiping may include one or more of deleting the datasets, encrypting the datasets and throwing away a decryption key, encrypting and then deleting the datasets, or other appropriate ways of making the datasets inaccessible by the user 104 at the device 102.

The following now illustrates details of a non-cooperative example. In this case, the application is not written to use selective wipe. For example, the application may simply be an app purchased from an app store, where the application is generally available for consumption rather than simply available to members of an organization. Embodiments may address the application not being specifically configured to implement selective wipe by intercepting and customizing the file (or other dataset) creation dialog to add an ‘account picker’. Thus, for example, when a user attempts to create a file, a user interface may be presented to the user asking the user to select the account associated with the file. This can be done using radio buttons, drop-down menus, checkboxes, etc. This change allows embodiments to know what account is being used to create the file. In the example above, if an email or word processing application did not know what account was used to create the document, embodiments could, through code inspection, find a dataset creation dialog, such as the ‘Mail Compose’ or ‘File New’ dialog boxes, and when that was displayed add a check box that said ‘this is a corporate document’. When the user selected the checkbox item, embodiments would save the name of the document and the account identifier in a local database. At this point the system works the same as illustrated, in the examples above, except that the client 118 would process the selective wipe. It would do so by looking in the database and deleting all documents where the account identifier matched the selective wipe account identifier.

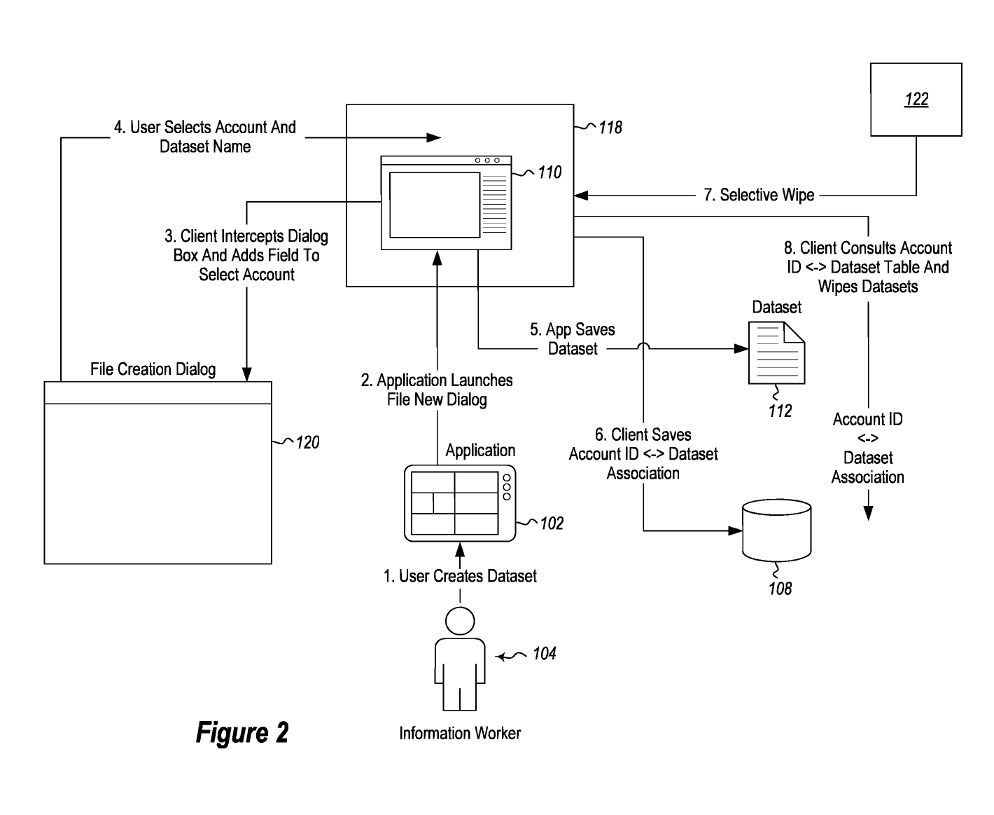

An example is illustrated in FIG. 2. FIG. 2 illustrates a user 104 of a device 102. As illustrated at step 1, the user initiates a dataset creation. As illustrated at step 2, the application 110 launches a file creation dialog box 120. As illustrated at step 3, a client 118 on the device 102 intercepts the file creation dialog box 120 and adds a field to select an account. In this example, the client would include code running inside the application process. This can be accomplished by injecting the SDK code into an application using an application wrapper tool. The application does not cooperate in tagging the datasets, instead the SDK code does this on behalf of the application by intercepting system calls. As illustrated at step 4, the user 104 can select a file name and an account using the file creation dialog box. For example, the user may be able to select an account from a drop-down user interface, by selection of a checkbox, by selection of a radio button, or other selection. The device 102 has multiple accounts associated with it, and thus the user may select from a number of different accounts. However, in some embodiments, the device 102 may have one or more personal accounts and only one managed account that needs to be managed by an organization. In such a case, the dialog box may simply prompt the user to indicate when the dataset is a dataset belonging to the organization or should otherwise be managed. As illustrated at step 5, the application 110 saves the document. As illustrated at step 6, the client 118 can associate an account identifier for a user selected account with an identifier for the created dataset in the data structure 108.

At some later time, as illustrated by step 7, a selective wipe is initiated. For example, the selective wipe may be initiated, by an organization's system administrator sending a wipe command. For example, the system administrator may be able to access a management service 122 that communicates with the client 118, The system administrator can indicate in the management system 122 that a selective wipe should be performed on the device 102. The management system 122 can communicate with the client 118 to cause the selective wipe to be performed.

Alternatively, the selective wipe may be initiated when the client 118 or other component on the device 102 identifies that the device is no longer compliant with some organization policy. For example, the client 118 can identify that the device 102 is no longer protected by a password or that the device is not protected by a sufficiently strong password, and/or that the device 102 no longer complies with one or more other policies.

As illustrated at step 8, the client 118 consults the data structure 108, which correlates account identifiers with dataset identifiers, and wipes any datasets associated with a particular managed account. Thus, for example, the selective wipe may identify an account associated with an account identifier. Alternatively, the selective wipe may identify an organization, which may be correlated with an account, such that an account identifier can be located. In alternative embodiments, the data could be tagged just based on the account. Embodiments would not need to identify a particular user. For example, if an individual worked at a company, embodiments could use the same ideas above that correlate data with a particular company and not a particular user, and then wipe that company's data. This could be useful when the corporation provisions the device but many users use it. Using the information from the data structure 108, datasets can be identified and wiped from the device 102. Thus, a selective wipe of datasets managed by an organization associated with a user account can be selectively wiped from a device 102 without affecting other data on the device 102 not managed by the organization or associated with a particular user account associated with the organization.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

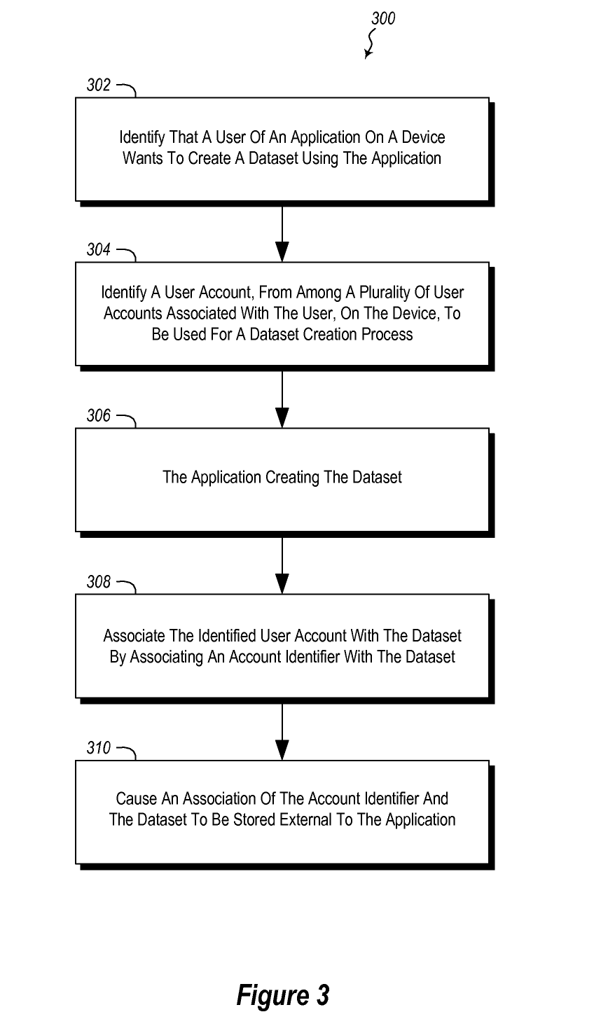

Referring now to FIG. 3, a method 300 is illustrated. The method 300 may be practiced in a computing environment. The method 300 includes acts for managing datasets on a device for improved efficiency in identifying and operating on managed datasets. The method 300 includes identifying that a user of an application on a device wants to create a dataset using the application (act 302). For example, embodiments may identify that a user has selected a “New” document user interface element.

The method 300 further includes identifying a user account, from among a plurality of user accounts associated with the user, on the device, to be used for a dataset creation process (act 304). For example, a device, such as device 102, may have various user accounts, such as a corporate or other organization account and a personal user account. Various alternatives for identifying a user account will be discussed in more detail below.

The method 300 further includes the application creating the dataset (act 306). For example, an application may create a new document or email.

The method 300 further includes associating the identified user account with the dataset by associating an account identifier with the dataset. For example, a unique number or other identifier associated with a user account may be associated with the new document or email.

The method 300 farther includes causing an association of the account identifier and the dataset to be stored external to the application. For example, the data structure 108 may be used to store the correlation.

The method 300 may be practiced where identifying a user account is based on an active user account for the application. For example, the application may have certain data in focus, may have certain folders selected that correspond to a particular user account, etc.

Alternatively, the method 300 may be practiced where identifying a user includes account receiving manual selection of a user account from a picker user interface element. For example, as illustrated above, a user interface may be provided that allows a user to select an account on document creation. Such a picker may be a drop down menu, radio buttons, checkboxes, etc.

The method 300 may be practiced where the association of the user account and the dataset is stored at a service external to the device.

The method 300 may further include receiving a selective wipe command for the user account. As a result, the method may further include identifying all datasets having the account identifier associated with them. The method may further include selectively wiping all datasets having the account identifier associated with them,

In an alternative embodiment, the method 300 may further include determining that the device no longer complies with a policy constraint. As a result, the method 300 may further include identifying all datasets having the account identifier associated with them. The method 300 may further include selectively wiping all datasets having the account identifier associated with them.

The method 300 may be practiced where associating the identified user account with the dataset by associating an account identifier with the dataset is performed by a wrapper external to the application. In particular, the wrapper can intercept data communications between an application and an operating system. The wrapper may also have functionality for identifying and wiping data. An example of the wrapper is illustrated above by the client 118. Alternatively, the method 300 may be practiced where associating the identified user account with the dataset by associating an account identifier with the dataset is performed by the application.

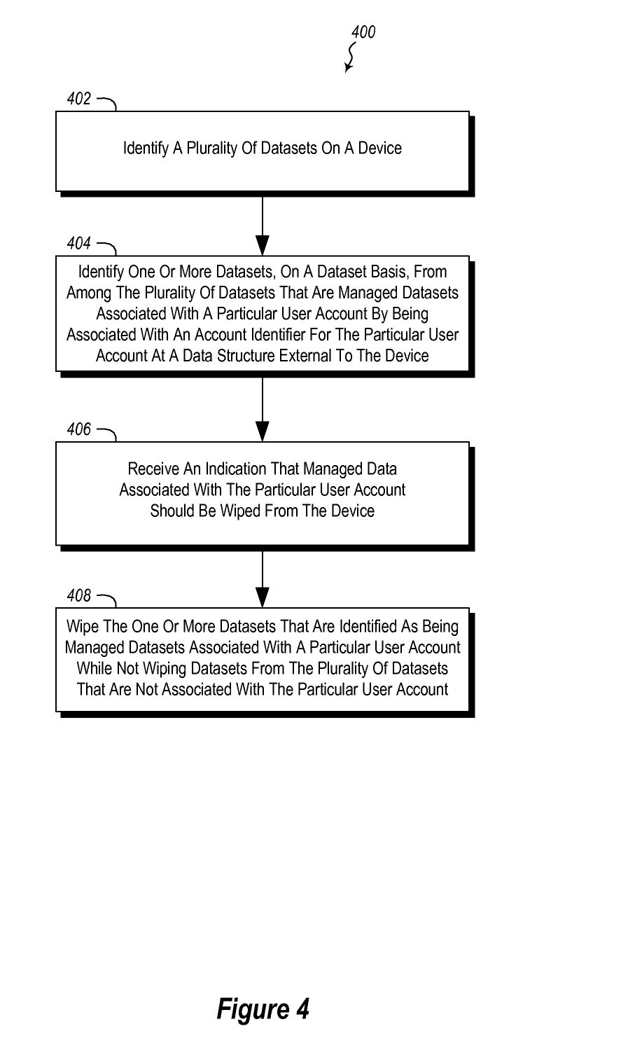

Referring now to FIG. 4, another method 400 is illustrated. The method 400 may be practiced in a computing environment. The method 400 includes acts for selectively wiping data from a device. The method includes identifying a plurality of datasets on a device (act 402).

The method 400 further includes identifying one or more datasets, on a dataset basis, from among the plurality of datasets that are managed datasets associated with a particular user account by being associated with an account identifier for the particular user account at a data structure external to the device (act 404). The managed datasets are associated with a particular user account by being associated with an account identifier for the particular user account.

The method 400 further includes receiving an indication that managed data associated with the particular user account should be wiped from the device (act 406).

The method 400 further includes wiping the one or more datasets that are identified as being managed datasets associated with a particular user account while not wiping datasets from the plurality of datasets that are not associated with the particular user account (act 408).

The method 400 may be performed where wiping the one or more datasets that are identified as being managed datasets associated with a particular user account is performed by a wrapper. For example, a wrapper that is included as part of the client 118 may be able to identify datasets to be wiped.

Alternatively or additionally, the method 400 may be performed where wiping the one or more datasets that are identified as being managed datasets associated with a particular user account is performed by an application that is configured to create one or more of the one or more datasets. For example, the application 110 may include functionality to wipe datasets. Thus, in some embodiments, the applications which created or interacted with datasets, may be used to wipe those same datasets.

The method 400 may be performed where receiving an indication that managed data associated with the particular user account should be wiped from the device comprises receiving an indication that the device is no longer managed. For example, the enrollment service 106 or another management service can send a message to the client 118 indicating that the device 102 is no longer managed by a management service.

The method 400 may be performed where receiving an indication that managed data associated with the particular user account should be wiped from the device comprises receiving an indication that the device no longer complies with policy and then perform wipe. For example, the device 102 can indicate its state. The client 118 can determine if this state complies with certain policy specified by a management service. If the device 102 no longer complies, the client can make this determination. In alternative embodiments, checks may be periodically performed by an external service to ensure the device complies with policy. When the device no longer complies with policy, a message may be sent to the client 118 indicating the non-compliance.

The method 400 may be performed where receiving an indication that managed data associated with the particular user account should be wiped from the device comprises receiving a selective wipe command. For example, a management service, such as the enrollment service 106, an associated service, or other service may indicate to the client 118 that certain data should be wiped. This can be performed, for example, by providing an account identifier.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM. ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described, features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include: Field--programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of managing datasets on a device for improved efficiency in identifying and operating on managed datasets, the method comprising:
identifying that a user of an application on a device wants to create a dataset using the application;
identifying a user account, from among a plurality of user accounts associated with the user, on the device, to be used fir a dataset creation process;
the application creating the dataset;
associating the identified user account with the dataset by associating an account identifier with the dataset; and
causing an association of the account identifier and the dataset to be stored external to the application.

2. The method of claim 1, wherein identifying a user account is based on an active user account for the application.

3. The method of claim 1, wherein identifying a user account comprises receiving manual selection of a user account from a picker user interface element.

4. The method of claim 1, wherein the association of the user account and the dataset is stored at a service external to the device.

5. The method of claim 1, further comprising:
receiving a selective wipe command for the user account;
as a result, identifying all datasets having the account identifier associated with them; and
selectively wiping all datasets having the account identifier associated with them.

6. The method of claim 1, further comprising:
determining that the device no longer complies with a policy constraint; and
as a result, identifying all datasets having the account identifier associated with them; and
selectively wiping all datasets having the account identifier associated with them.

7. The method of claim 1, wherein associating the identified user account with the dataset by associating an account identifier with the dataset is performed by a wrapper external to the application.

8. The method of claim 1, wherein associating the identified user account with the dataset by associating an account identifier with the dataset is performed by the application.

9. In a computing environment, a method of selectively wiping data from a device, the method comprising:
identifying a plurality of datasets on a device;
identifying one or more datasets, on a dataset basis, from among the plurality of datasets that are managed datasets associated with a particular user account by being associated with an account identifier for the particular user account at a data structure external to the device, wherein the managed datasets are associated with a particular user account by being associated with an account identifier for the particular user account;
receiving an indication that managed data associated with the particular user account should be wiped from the device; and
as a result, wiping the one or more datasets that are identified as being managed datasets associated with a particular user account while not wiping datasets from the plurality of datasets that are not associated with the particular user account.

10. The method of claim 9, wherein wiping the one or more datasets that are identified, as being managed datasets associated with a particular user account is performed by a wrapper.

11. The method of claim 9, wherein wiping the one or more datasets that are identified as being managed datasets associated with a particular user account is performed by an application that is configured to create one or more of the one or more datasets.

12. The method of claim 9, wherein receiving an indication that managed data associated with the particular user account should be wiped from the device comprises receiving an indication that the device is no longer managed.

13. The method of claim 9, wherein receiving an indication that managed data associated with the particular user account should be wiped from the device comprises receiving an indication that the device no longer complies with policy and then perform wipe.

14. The method of claim 9, wherein receiving an indication that managed data associated with the particular user account should be wiped from the device comprises receiving a selective wipe command.

15. In a computing environment, a device configured to manage datasets for improved efficiency in identifying and operating on managed datasets, the device comprising:
one or more applications configured to create datasets;
wherein device is configured to identify accounts associated with created datasets; and
wherein the device is configured to tag created datasets with account identifiers.

16. The device of claim 15, wherein one or more of the applications on the device are configured to identify active accounts and to tag datasets with account identifiers.

17. The device of claim 15, further comprising a client configured to tag created datasets with account identifiers.

18. The device of claim 17, wherein the client is configured to intercept a dataset creation dialog box and to customize the dataset creation dialog box to provide an account picker for a user to select an account.

19. The device of claim 15, wherein the device is configured to selectively wipe datasets by account identifiers.

20. The device of claim 19, wherein a client is configured to selective wipe datasets by account identifier.
